(19) United States
(12) Patent Application Publication
(10) Pub. No.: US 2017/0036931 A1
(43) Pub. Date: Feb. 9, 2017

(54) METHODS AND KITS FOR STABILIZING OXIDIZERS AND SANITIZING WATER

(71) Applicant: Arch Chemicals, Inc., Allendale, NJ (US)

(72) Inventor: Michael J. UNHOCH, Tryone, GA (US)

(21) Appl. No.: 15/299,903

(22) Filed: Oct. 21, 2016

Related U.S. Application Data
(62) Division of application No. 12/806,073, filed on Aug. 5, 2010, now abandoned.
(60) Provisional application No. 61/275,250, filed on Aug. 27, 2009.

(51) Int. Cl. C02F 1/68; C02F 1/58; C02F 1/54; C02F 1/72; C02F 1/52

(52) U.S. Cl. CPC C02F 1/685; C02F 1/722; C02F 1/72; C02F 1/5236; C02F 1/54; C02F 1/58; C02F 2103/42

(57) ABSTRACT

The present invention is directed to a kit and method for preventing a body of water from clouding, comprising: (a) a first container containing a first water treatment composition, the first water treatment composition comprising 2,2-dibromo-3-nitrilopropionamide (DBNPA); and (b) a second container containing a second water treatment composition, the second water treatment composition comprising an oxidizer; wherein the body of water contains polyhexamethylene biguanide (PHMB). The present invention is also directed to a kit and method for remediating a cloudy body of water, comprising: (a) a first container containing a first water treatment composition, the first water treatment composition comprising 2,2-dibromo-3-nitrilopropionamide (DBNPA); (b) a second container containing a second water treatment composition, the second water treatment composition comprising an oxidizer; and (c) a third container containing a third water treatment composition, the third water treatment composition comprising a flocculant; wherein the body of water contains polyhexamethylene biguanide (PHMB).

### CROSS-REFERENCE TO RELATED APPLICATIONS

This application is a divisional of U.S. patent application Ser. No. 12/806,073 filed Aug. 5, 2010, which claims the benefit of U.S. Provisional Patent Application Ser. No. 61/275,250 filed Aug. 27, 2009, each of which is incorporated herein by reference in its entirety.

### BACKGROUND OF THE INVENTION

1. Field of the Invention

The present invention is directed to kits and methods for treating bodies of water, and more specifically to methods and kits for preventing water from clouding or for remediation of cloudy water.

2. Brief Description of the Related Art

2,2-Dibromo-3-nitrilopropionamide (DBNPA) is a biocide which is used in industrial water treatment, cooling systems and paper mills. DBNPA is an efficient biocide with a rapid microbiocidal broad-spectrum activity, especially in water systems that contain high organic loads. Various applications of DBNPA have been disclosed, including the following:

U.S. Pat. No. 7,008,545 to Cronan et al. discloses synergistic mixtures of biocides and their use to control the growth of microorganisms in aqueous systems. The disclosed method of using the synergistic mixtures entails adding an effective amount of a nitrogenous compound activated by an oxidant and at least one non-oxidizing biocide to an aqueous system. The amount of activated nitrogenous compound and non-oxidizing biocide is selected to result in a synergistic biocidal effect.

U.S. Pat. No. 7,285,224 to Barak discloses a process for killing microorganisms and controlling biofouling in high chlorine demand waters comprises mixing two components, one of which is an oxidant and the other an ammonium salt, and adding the mixture immediately to the aqueous system to be treated.

U.S. Pat. No. 7,449,120 to Barak discloses a process for killing microorganisms and controlling biofouling in high chlorine demand waters comprises mixing two components, one of which is an oxidant and the other an ammonium salt, and adding the mixture immediately to the aqueous system to be treated.

Pool water treated with PHMB shows increased consumption of its oxidizer over time and when the residual is totally exhausted the pool water will get cloudy. This can be very expensive for the pool owner because merely replacing the oxidizer does not remediate the clouding, and adds unnecessary and unproductive cost to the maintenance of the pool. U.S. Pat. No. 6,696,093 to Ney et al. discloses the use of aldehyde donors, such as 1,3-bis(hydroxymethyl)-5,5-dimethylhydantoin, to stabilize peroxides such as hydrogen peroxide in aqueous solutions and in particular circulating water slurries in papermaking applications. The stabilizer was added initially and on a weekly basis with the oxidizer to minimize loss of oxidizer. Although it was more effective than not using an oxidizer stabilizer for papermaking, new technologies more relevant to recreational water usage, such as pools, spas, and hot tubs, is needed.

### SUMMARY OF THE INVENTION

In one aspect, the present invention is directed to a kit for stabilizing oxidizers and preventing a body of water from clouding, comprising: (a) a first container containing a first water treatment composition, the first water treatment composition comprising 2,2-dibromo-3-nitrilopropionamide (DBNPA); and (b) a second container containing a second water treatment composition, the second water treatment composition comprising an oxidizer; wherein the body of water contains polyhexamethylene biguanide (PHMB).

In another aspect, the present invention is directed to a kit for stabilizing oxidizers and remediating a cloudy body of water, comprising: (a) a first container containing a first water treatment composition, the first water treatment composition comprising 2,2-dibromo-3-nitrilopropionamide (DBNPA); (b) a second container containing a second water treatment composition, the second water treatment composition comprising an oxidizer; and (c) a third container containing a third water treatment composition, the third water treatment composition comprising a flocculant; wherein the body of water contains polyhexamethylene biguanide (PHMB).

In another aspect, the present invention is directed to a method of stabilizing oxidizers and preventing a body of water from clouding, comprising the steps of: (a) providing a body of water containing PHMB; (b) adding to the body of water a first treatment composition comprising 2,2-dibromo-3-nitrilopropionamide (DBNPA), and (c) adding to the body of water a second treatment composition comprising an oxidizer.

In another aspect, the present invention is directed to a method of stabilizing oxidizers and remediating a cloudy body of water, comprising the steps of (a) providing a body of water containing PHMB; (b) adding to the body of water a first treatment composition comprising 2,2-dibromo-3-nitrilopropionamide (DBNPA); (c) adding to the body of water a second treatment composition comprising an oxidizer; and (d) adding to the body of water a third treatment composition comprising a flocculant and/or filter aid.

These and other aspects will be more understood from the following detailed description of the invention.

### BRIEF DESCRIPTION OF THE FIGURES

The invention will be better understood from the following detailed description of the invention in conjunction with the several figures in which:

FIG. 1 are photographs showing the skimmer and return lines in test pool 3;

FIG. 2 are photographs showing the skimmer and return lines in test pool 4;

FIG. 3 are photographs showing the skimmer and return lines in test pool 5;

FIG. 4 is a graph showing the results of remedial treatment of test pool 3; and

FIG. 5 is a graph showing the results of remedial treatment of test pool 4.

### DETAILED DESCRIPTION OF THE INVENTION

The present invention is directed to methods and kits for preventing a body of water from clouding by stabilizing the oxidizer (such as peroxide) in the water using 2,2-dibromo-3-nitrilopropionamide (DBNPA) added to the pool either on a daily or weekly basis. The weekly basis is preferred because the other products are added once a week for user convenience. The kit generally comprises (a) a first container containing a first water treatment composition that includes 2,2-dibromo-3-nitrilopropionamide (DBNPA); and (b) a second container containing a second water treatment composition that includes an oxidizer. The kit of the invention is added to a body of recreational water that already contains some level of polyhexamethylene biguanide (PHMB). The kits of the present invention preferably include instructions describing the method and frequency of administering the contents of the kit to the body of water to be treated.

As indicated above, the kit of the present invention includes a first container that contains a first water treatment composition that contains 2,2-dibromo-3-nitrilopropionamide (DBNPA). The first water treatment composition preferably contains from 1 to 100 percent by weight DBNPA (liquid or solid), and more preferably from 5 to 40 percent by weight DBNPA, based on the total weight of said first water treatment composition. The first water treatment composition may be in solid form, such as a briquette, tablet, or granule form, or a liquid, paste, gel, dispersion, suspension, or solution form in concentrations ranging from 0.5 to 100 wt %, more preferably 20-95 wt %, and most preferably 50-90 wt %. When used in a liquid state, DBNPA in the first composition is preferably about 5-20 wt %. The first water treatment composition may be contained in a bottle, pouch, a dissolvable or biodegradable bag, or other suitable feeder or container.

The second container in the kit of the present invention includes a second water treatment composition that includes an oxidizer compound. Useful oxidizer compounds include alkali and alkaline earth perborate salts, alkali and alkaline earth percarbonate salts, alkali and alkaline earth persulfate salts, hydrogen peroxide, percarboxylic acid and peracetic acid, and combinations thereof. One particularly useful oxidizer is hydrogen peroxide. Preferably, the oxidizer comprises from 1 to 100 percent by weight, based on the total weight of the second water treatment composition, and more preferably from 10 to 50 percent by weight, based on the total weight of the second water treatment composition. Like the first water treatment composition, this second water treatment composition may be in solid form, such as a briquette, tablet, or granule form, or a liquid, paste, gel, dispersion, suspension, or solution form in the same concentration ranges as the first water treatment composition above. The second water treatment composition may be contained in a bottle, pouch, a dissolvable or biodegradable bag, or other suitable feeder or container.

In a related embodiment, the kit of the present invention may be used in a remedial application for treating a cloudy body of water such as in a pool, spa, or hot tub. In this particular embodiment, the kit of the invention includes (a) a first container containing a first water treatment composition that includes 2,2-dibromo-3-nitrilopropionamide (DBNPA); (b) a second container containing a second water treatment composition that includes an oxidizer as described above; and (c) a third container containing a third water treatment composition that includes a flocculant and/or filter aid.

In this embodiment, the first water treatment composition preferably contains from 1.0 to 100 percent by weight DBNPA, and more preferably from 20 to 90 percent by weight DBNPA, based on the total weight of said first water treatment composition. The first water treatment composition may be in solid form, such as a briquette, tablet, or granule form, or a liquid, paste, gel, dispersion, suspension, or solution form in the same concentration ranges as the first water treatment composition above. This water treatment composition may be contained in a bottle, pouch, a dissolvable or biodegradable bag, or other suitable feeder or container.

The second container in this embodiment includes a second water treatment composition that includes an oxidizer compound. Useful oxidizer compounds include the same oxidizers as described above, and particularly hydrogen peroxide. Preferably, the oxidizer in this embodiment comprises from 2 to 100 percent by weight, based on the total weight of the second water treatment composition, and more preferably from 10 to 50 percent by weight, based on the total weight of the second water treatment composition. Like the first water treatment composition, this second water treatment composition may be in solid form, such as a briquette, tablet, or granule form, or a liquid, paste, gel, dispersion, suspension, or solution form in the same concentration ranges as the first water treatment composition above. This water treatment composition may be contained in a bottle, pouch, a dissolvable or biodegradable bag, or other suitable feeder or container.

The third container in this embodiment includes a flocculant or filter aid to assist in the removal of microscopic particles which would otherwise cause the water to be turbid (cloudy) and which would be difficult or impossible to remove by filtration alone. Useful flocculants include alum, polyaluminum chloride, aluminum chlorohydrate, aluminum sulfate, calcium oxide, calcium hydroxide, iron (II) chloride, iron (II) sulfate, polyacrylamide, polydiallyldimethylammonium chloride (polyDADMAC), sodium aluminate, sodium silicate, and combinations thereof. Useful filter aids include Alum, cellulose, chitin, chitosan, diatomaceous earth, and the like, as well as combinations of these. Preferably the amount of flocculant or filter aid included in the third container ranges from 5 to 100 percent by weight, and more preferably from 10 to 50 percent by weight, based on the total weight of said third water treatment composition. Like the others, this water treatment composition may be contained in a bottle, pouch, a dissolvable or biodegradable bag, or other suitable feeder or container.

The compositions according to the present invention may also contain additives known in the water treatment art. These additives include but are not limited to pigments, binders, water softeners, phosphate removers, corrosion inhibitors, dissolution rate modifiers, lubricants, color-containing salts, biocides, buffers, chelating agents, other bactericides, algaecides, fungicides, sequestering agents, clarifiers, enzymes, pigments, dyes, thickeners, fragrances, surfactants, co-solvents, biodisperants, corrosion inhibitors, biopenetrants, sorbitan monostearate, sulfamic acid, tallowpropylamine diamine, cocopropylamine diamine, oleylpropylamine diamine, stearyldimethylbenzylammonium chloride, and combinations thereof. These additives may be pre-blended with any of the components of the composition, and are generally present in the composition of the invention in amounts ranging from 0.2 to 10 weight percent.

As mentioned above, the invention also encompasses kits and methods of controlling algae or other microorganisms in a body of recirculating or stagnant water. Preferably, bodies of recirculating water such as pools, spas, or hot tubs, already include PHMB at levels ranging up to about 20 PPM, and preferably from 2 to 12 PPM.

The composition and method of the present invention may be used in any recirculating water system where microorganism infestation or biofilm build-up could occur, for example swimming pools, spas, hot tubs, decorative ponds, and plumbing lines, industrial water treatment, cooling systems, paper mills, and the like. The kits and methods of the invention are particularly useful in remedially treating cloudy water and preventing clear water from becoming cloudy. The kits and methods of the present invention are also useful in treating or preventing biofilm buildup in all parts of any recirculating water system (e.g., lines, skimmers, and the like), or in industrial applications. In use as a treatment for swimming pools, the composition of the invention is added to a swimming pool recirculating water system to achieve desired concentration ranges and demonstrates a synergistic effect between the ingredients. Modes of application include manual additions, as well as automated dosing (e.g., daily or weekly automated dosing). While not being bound by any particular theory, it is believed that DBNPA stabilizes the oxidizer component in the presence of catalase and results in water clarity when the invention is used on a regular (e.g., weekly) basis.

In use, the kits of the invention are used as preventative or remedial applications. For preventative maintenance, a kit containing the first and second water treatments is used. The water treatment compositions can be added in any order. Preferably, the final concentration of DBNPA ranges from 0.5 to 12 PPM, and more preferably from 3 to 6 PPM. The final concentrations of oxidizer range from 0.1 PPM to 400 PPM, preferably from 1 to 100 PPM, and more preferably from 5 to 25 PPM (as active peroxide). For remedial use, the kit containing the first, second and third treatment compositions are used, and can be added in any order. Preferably, the final concentration of DBNPA ranges from 0.5 to 24 PPM, and more preferably from 6 to 12 PPM. The final concentrations of oxidizer range from 1 PPM to 400 PPM, and more preferably from 25 to 200 PPM (as active peroxide). The final concentration of flocculant preferably ranges from 2 PPM to 100 PPM and more preferably from 10 PPM to 40 PPM. If a filter aid is also included, it may be added directly to a filter apparatus ranging in size from 0.25 to 10 lbs. and more preferably from 0.5 to 2.5 lbs.

### EXAMPLES

The following examples are meant to illustrate, but in no way limit the present invention.

### Example 1

### DBNPA as Oxidizer Stabilizer

Test pools in Brazil were run in the preventative mode to evaluate the effect of two treatment systems at maintaining good water clarity and oxidizer residual. The pool pumps were operated for a minimum of 8 hours per day. Each pool was challenged twice per week with eight species of bacteria and four species of fungi typically found in swimming pool water. These microorganisms include species of the fungi Paecilomyces and Trichoderma, and species of the bacteria Alcaligenes, Chryseobacterium and Sphingomonas. Each inoculation represents a total addition of 0.8×10⁶ microorganisms per test pool. The visual clarity, turbidity and oxidizer concentration were monitored throughout the work week. Each of the pools received a single initial dose of 27.5 ppm hydrogen peroxide and 10 ppm active PHMB (50 ppm as Sanitizer product) at the beginning of the study. The PHMB was maintained in each pool at 6-10 ppm active (30-50 ppm Sanitizer) by adding a single dose weekly. The hydrogen peroxide (oxidizer) was added weekly to each pool to a level of about 6.9 ppm unless a reading <5.5 ppm was measured. At concentrations at or below 5.5 ppm, a minimum of an initial dose of 27.5 ppm was added until a value above 5.5 ppm was obtained. All chemical additions were recorded. There were no chemical doses administered on Saturday or Sunday. Three pools were administered oxidizer stabilizer compounds (DBNPA or DMDMH) as follows:

Pool 2

Pool 2 received daily minimum doses of 0.5 ppm active DBNPA in addition to the PHMB and hydrogen peroxide as listed above.

Pool 5

Pool 5 received daily minimum doses of 2.0 ppm active DBNPA in addition to the PHMB and hydrogen peroxide as listed above.

Pool 7

Hydroxymethyl-5,5-dimethylhydantoin (DMDMH) is currently a commercial oxidizer stabilizer used with PHMB. It is a 17% active and is described in U.S. Pat. No. 6,696,093. Pool 7 was dosed initially at a concentration of 4.0-5.0 ppm active chemical and weekly at a concentration of 1-1.5 ppm active chemical.

The results of these test pools are summarized in Table I.

TABLE I

| | Average Oxidizer | Average Visual | Average | Peroxide |
|---|---|---|---|---|
| Pool | Concentration | Clarity (0-4, | Turbidity | Use per |
| # | (H₂O₂, ppm) | 0 being best) | (NTU) | Week (ppm) |
| 2 | 96 ± 46 | 0.3 | 0.4 ± 0.3 | 8.0 |
| 5 | 65 ± 24 | 0.1 | 0.3 ± 0.1 | 6.3 |
| 7 | 21 ± 22 | 0.6 | 0.5 ± 0.2 | 15.7 |

The data in Table I show that DBNPA stabilized the oxizer (hydrogen peroxide) better than DMDMH as shown by the average oxidizer readings combined with the peroxide use per week. In addition, a more stable oxidizer resulted in improved water clarity and reduction in overall treatment cost as evidenced by the lower values of turbidity and peroxide use in pools 2 and 5.

### Example 2

### DBNPA as Oxidizer Stabilizer

Test pools in United States were run in the preventative mode to evaluate the effect of two treatment systems at maintaining good water clarity and oxidizer residual. The pool pumps were operated for a minimum of 8 hours per day. Each pool was challenged twice per week with eight species of bacteria and four species of fungi typically found in swimming pool water. These microorganisms include species of the fungi Paecilomyces and Trichoderma, and species of the bacteria Alcaligenes, Chryseobacterium and Sphingomonas. Each inoculation represents a total addition of 0.8×10⁶ microorganisms per test pool. The visual clarity, turbidity and Oxidizer concentration were monitored throughout the work week. Each of the pools received a single initial dose of 27.5 ppm hydrogen peroxide and 10 ppm active PHMB (50 ppm as Sanitizer product) at the beginning of the study. The PHMB was maintained in each pool at 6-10 ppm active (30-50 ppm Sanitizer) by adding a single dose weekly. Hydrogen peroxide (oxidizer) was added weekly to each pool to a concentration of about 6.9 ppm unless a reading <5.5 ppm was measured. At concentrations at or below 5.5 ppm, a minimum of an initial dose of 27.5 ppm was added until a value above 5.5 ppm was obtained. All chemical additions were recorded. There were no chemical doses administered on Saturday, Sunday, or holidays. Three pools were administered oxidizer stabilizer compounds (DBNPA or DMDMH) and one pool was not administered any oxidizer stabilizers follows:

Pool 3

Pool 3 received daily doses of 1.5 ppm active DBNPA in addition to the PHMB and hydrogen peroxide as listed above.

Pool 4

Pool 4 received weekly doses of 6.0 ppm active DBNPA in addition to the PHMB and hydrogen peroxide as listed above.

Pool 5

Pool 5 received doses of PHMB and hydrogen peroxide as listed above as well as a an initial and weekly doses of algaecide (50% alkyldimethylbenzylammonium chloride) at rates of 1.4 and 0.6 ppm active, respectively. No stabilizer was added.

Pool 8

Hydroxymethyl-5,5-dimethylhydantoin (DMDMH) is currently a commercial oxidizer stabilizer used with PHMB. It is a 17% active and is described in U.S. Pat. No. 6,696,093. It was dosed initially at a concentration of 4.0-5.0 ppm active chemical and weekly at a concentration of 1-1.5 ppm active chemical.

The results of these test pools are summarized in Table II.

TABLE II

| | Average Oxidizer | Average Visual | Average | Peroxide |
|---|---|---|---|---|
| Pool | Concentration | Clarity (0-4, | Turbidity | Use per |
| # | (H₂O₂, ppm) | 0 being best) | (NTU) | Week (ppm) |
| 3 | 58 ± 22 | 0 | 0.5 ± 0.3 | 8.2 |
| 4 | 65 ± 24 | 0 | 0.5 ± 0.2 | 8.9 |
| 5 | 21 ± 22 | 0.4 | 0.7 ± 0.6 | 17.9 |
| 8 | 54 ± 23 | 0 | 0.4 ± 0.3 | 8.9 |

The data in Table II show the following when comparing DBNPA-treated pools with pools containing no stabilizer and pools containing DMDMH as a stabilizer. First, the DBNPA when added at either weekly or daily doses performed as well as the DMDMH at stabilizing the peroxide in the pool. Second, the DBNPA when added at either weekly or daily doses performed as well as the DMDMH at maintaining water clarity in the pool. Third, the pool without a stabilizer had highest peroxide use and worst water clarity. Fourth, the pools with stabilizer have little or no biofilm development in the return lines.

### Example 3

### Biofilm Control

Test pools in United States were run in the preventative mode to evaluate the treatment systems at maintaining good water clarity and oxidizer residual. The pool pumps were operated for a minimum of 8 hours per day. Each pool was challenged twice per week with eight species of bacteria and four species of fungi typically found in swimming pool water. These microorganisms include species of the fungi Paecilomyces and Trichoderma, and species of the bacteria Alcaligenes, Chryseobacterium and Sphingomonas. Each inoculation represents a total addition of 0.8×10⁶ microorganisms per test pool. The visual clarity, turbidity and oxidizer concentration were monitored throughout the work week. Each of the pools received a single initial dose of 27.5 ppm hydrogen peroxide and 10 ppm active PHMB (50 ppm as Sanitizer product) at the beginning of the study. The PHMB was maintained in each pool at 6-10 ppm active (30-50 ppm Sanitizer) by adding a single dose weekly. The hydrogen peroxide was added weekly to each pool at a concentration of 6.9 ppm unless a reading 0 ppm was measured. At concentrations at 0 ppm a minimum initial dose of 27.5 ppm was added. All chemical additions were recorded. There were no chemical doses administered on Saturday, Sunday or holidays. Two pools were administered oxidizer stabilizer compounds (DBNPA) and one pool was not administered any oxidizer stabilizers follows:

Pool 3

Pool 3 received weekly doses of 3.0 ppm active DBNPA in addition to the PHMB and hydrogen peroxide as listed above.

Pool 4

Pool 4 received weekly doses of 3.0 ppm active DBNPA in addition to the PHMB and hydrogen peroxide as listed above.

Pool 5

Pool 5 received doses of PHMB and hydrogen peroxide as listed above as well as a an initial and weekly doses of algaecide (50% alkyldimethylbenzylammonium chloride) at rates of 1.4 and 0.6 ppm active, respectively. No stabilizer was added.

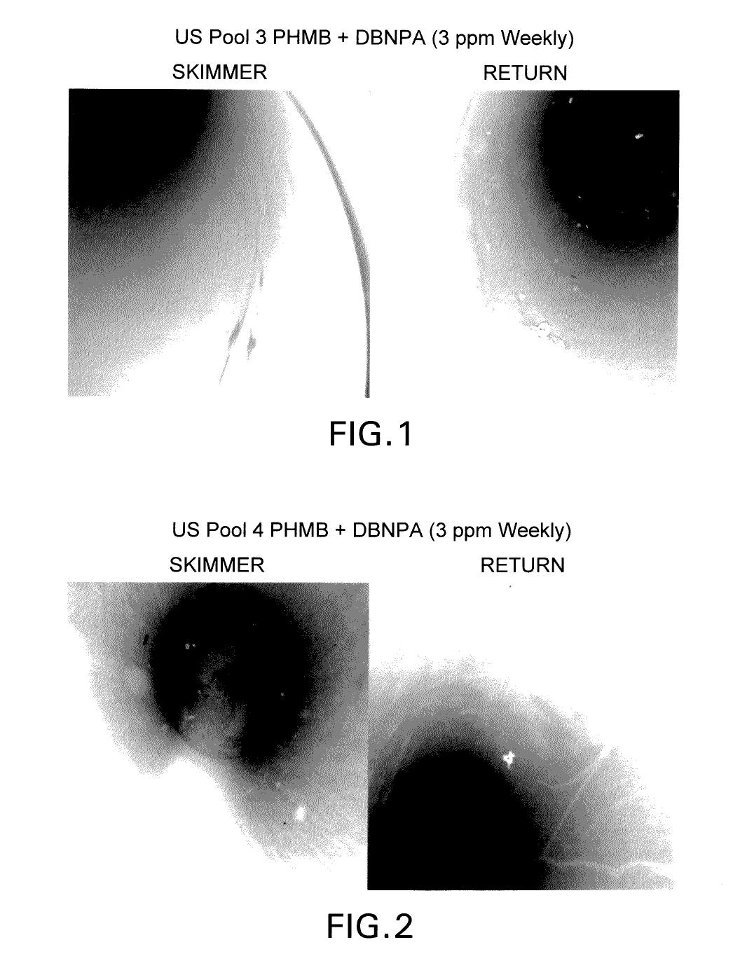

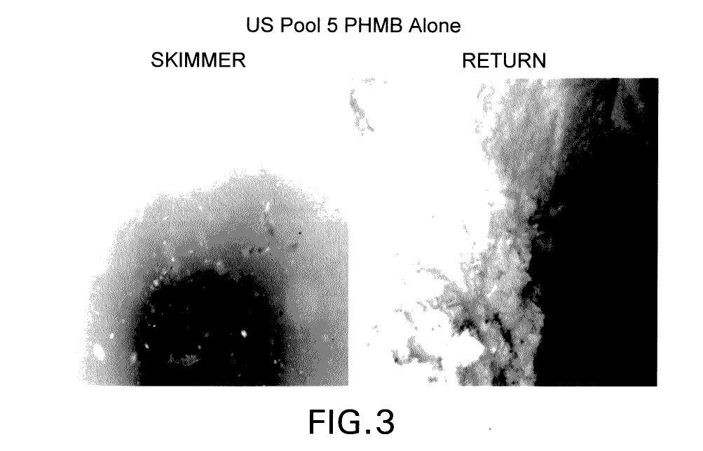

Each pool was analyzed for biofilms development using a Karl Storz Model 81048020 Fiber optic scope. Photographs of the skimmer and return lines were taken near the end of the test and are show in FIG. 1 (Pool 3), FIG. 2 (Pool 4), and FIG. 3 (Pool 5). FIGS. 1-3 illustrate a minimum of two seasons on the treatment. As shown in FIGS. 1-3, a larger amount of biofilm was found in the return lines of the pool that did not contain the DBNPA stabilizer (Pool 5).

### Example 4

### Remediation Using Stabilizer, Oxidizer and Flocculant

Two test pools in United States were run in the preventative mode to evaluate the treatment systems at maintaining good water clarity and oxidizer residual. The pool pumps were operated for a minimum of 8 hours per day. Each pool was challenged twice per week with eight species of bacteria and four species of fungi typically found in swimming pool water. These microorganisms include species of the fungi Paecilomyces and Trichoderma, and species of the bacteria Alcaligenes, Chryseobacterium and Sphingomonas. Each inoculation represents a total addition of 0.8×10⁶ microorganisms per test pool. The visual clarity, turbidity and oxidizer concentration were monitored throughout the work week. Each of the pools received a single initial dose of 27.5 ppm hydrogen peroxide and 10 ppm active PHMB (50 ppm as sanitizer product) at the beginning of the study. The PHMB was maintained in each pool at 6-10 ppm active (30-50 ppm sanitizer) by adding a single dose weekly. Hydrogen peroxide (oxidizer) was added weekly to each pool at a concentration of about of 6.9 ppm unless a reading 0 ppm was measured. At concentrations of 0 ppm, a minimum of an initial dose of 27.5 ppm was added. Pools 3 and 4 received weekly doses of 3.0 ppm active DBNPA (stabilizer) in addition to the PHMB and hydrogen peroxide as listed above. All chemical additions were recorded. Each pool also received a 1 ppm monthly dose of zinc sulfate monohydrate for algae prevention. There were no chemical doses administered on Saturday, Sunday or holidays. Neither pool received chemical dosing for 14 days, resulting in hazy water and no oxidizer residual in either pool. Both pools were given a remedial treatment immediately following the 15 day period, consisting of a 6 ppm DBNPA (stabilizer) dose, a 27.5 ppm hydrogen peroxide (oxidizer) dose, and 18 ppm aluminum sulfate (flocculant) added directly into the skimmer as filter aid. Following these additions, the pool pump was continuously run until the water was clear. The week after the remedial treatment was performed, the pools were returned to the preventative method consisting of 3 ppm weekly DBNPA stabilizer treatments and 6.9 ppm weekly hydrogen peroxide oxidizer additions.

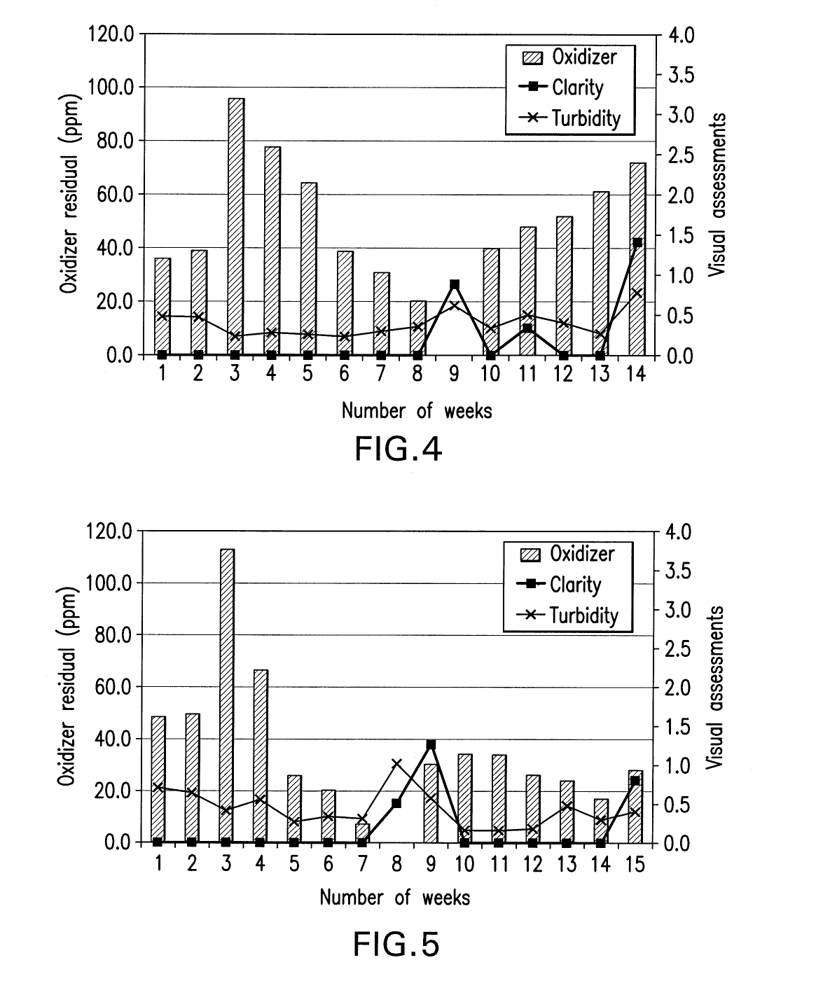

The pool parameter profiles shown in FIG. 4 (Pool 3) and FIG. 5 (Pool 4) illustrate how both pools became hazy and without oxidizer residuals as a result of no chemical additions for 14 days. FIGS. 4 and 5 also show the rapid return of water clarity and establishment of oxidizer residuals after just one treatment. As shown in FIG. 4, pool 3 recovered within 3 days post treatment. Water clarity improved from 1.0 visual assessment to 0, and oxidizer residual increased from 0 ppm to 12 ppm. As shown in FIG. 5, water clarity in pool 4 improved overnight from 1.5 visual assessment to 0.5, and the measured turbidity was reduced from 0.75 ntu to 0.41 ntu. The oxidizer residual also increased from 0 ppm to 15 ppm. Both pools operated with crystal clear water clarity and stable oxidizer residuals for 5 weeks following remedial treatment.

While the invention has been described above with reference to specific embodiments thereof, it is apparent that many changes, modifications, and variations can be made without departing from the inventive concept disclosed herein. Accordingly, it is intended to embrace all such changes, modifications, and variations that fall within the spirit and broad scope of the appended claims.

1. A kit for stabilizing oxidizers and preventing a body of water containing polyhexamethylene biguanide (PHMB) from clouding, comprising:
(a) a first container containing a first water treatment composition, said first water treatment composition comprising 2,2-dibromo-3-nitrilopropionamide (DBNPA); and
(b) a second container containing a second water treatment composition, said second water treatment composition comprising an oxidizer.

2. The kit of claim 1, wherein said DBNPA comprises from 1 to 100 percent by weight, based on the total weight of said first water treatment composition.

3. The kit of claim 1, wherein said DBNPA is in solid form.

4. The kit of claim 3, wherein the solid form is a briquette, tablet, or granule form.

5. The kit of claim 1, wherein said DBNPA is in liquid, paste, gel, dispersion, suspension, or solution form.

6. The kit of claim 1, wherein said oxidizer is selected from the group consisting of alkali and alkaline earth perborate salts, alkali and alkaline earth percarbonate salts, alkali and alkaline earth persulfate salts, hydrogen peroxide, percarboxylic acid and peracetic acid, and combinations thereof.

7. The kit of claim 6, wherein said oxidizer is hydrogen peroxide.

8. The kit of claim 1, where said oxidizer comprises from 1 to 100 percent by weight, based on the total weight of said second water treatment composition.

9. The kit of claim 1, wherein the concentration of said polyhexamethylene biguanide (PHMB) in said body of water ranges up to about 20 PPM.

10. A kit for stabilizing oxidizers and remediating a cloudy body of water containing polyhexamethylene biguanide (PHMB), comprising:
(a) a first container containing a first water treatment composition, said first water treatment composition comprising 2,2-dibromo-3-nitrilopropionamide (DBNPA);
(b) a second container containing a second water treatment composition, said second water treatment composition comprising an oxidizer; and
(c) a third container containing a third water treatment composition, said third water treatment composition comprising a flocculant.

11. The kit of claim 10, wherein said DBNPA comprises from 1.0 to 100 percent by weight, based on the total weight of said first water treatment composition.

12. The kit of claim 10, wherein said DBNPA is in solid form.

13. The kit of claim 12, wherein the solid form is a briquette, tablet, or granule form.

14. The kit of claim 10, wherein said DBNPA is in liquid, paste, gel, dispersion, suspension, or solution form

15. The kit of claim 10, wherein said oxidizer is selected from the group consisting of alkali and alkaline earth perborate salts, alkali and alkaline earth percarbonate salts, alkali and alkaline earth persulfate salts, hydrogen peroxide, percarboxylic acid and peracetic acid, and combinations thereof.

16. The kit of claim 15, wherein said oxidizer is hydrogen peroxide.

17. The kit of claim 10, where said oxidizer comprises from 2 to 100 percent by weight, based on the total weight of said second water treatment composition.

18. The kit of claim 10, wherein said flocculant is selected from the group consisting of alum, polyaluminum chloride, aluminum chlorohydrate, aluminum sulfate, calcium oxide, calcium hydroxide, iron (II) chloride, iron (II) sulfate, polyacrylamide, polydiallyldimethylammonium chloride (polyDADMAC), sodium aluminate, sodium silicate, and combinations thereof.

19. The kit of claim 10, wherein said flocculant comprises from 5 to 100 percent by weight based on the total weight of said third water treatment composition.

20. The kit of claim 10, further comprising a filter aid selected from the group consisting of alum, cellulose, chitin, chitosan, diatomaceous earth, and combinations thereof.

21. The kit of claim 10, wherein the concentration of said polyhexamethylene biguanide (PHMB) in said body of water ranges up to about 20 PPM.

22. The kit of claim 1, further comprising instructions.
